(19) United States
(12) Patent Application Publication
(10) Pub. No.: US 2025/0000740 A1
(43) Pub. Date: Jan. 2, 2025

(54) FLUID DRIVEN DIAPHRAGM FOR PERSONAL DEVICES

(71) Applicant: Obotics Inc., North Gower (CA)

(72) Inventor: Bruce Murison, North Gower (CA)

(21) Appl. No.: 18/759,737

(22) Filed: Jun. 28, 2024

Related U.S. Application Data
(60) Provisional application No. 63/511,438, filed on Jun. 30, 2023.

(51) Int. Cl. A61H 19/00

(52) U.S. Cl. CPC A61H 19/40; A61H 19/30

(57) ABSTRACT

Adult devices having a reservoir a dual sided reciprocating pump can include a diaphragm covering a portion of the reservoir. The outflow of the reciprocating pump is directed onto the diaphragm by an output structure that causes vibrations on the diaphragm as waves, ripples, or other similar patterns on the diaphragm.

### CROSS-REFERENCE TO RELATED APPLICATIONS

This application relates to and claims the benefit of U.S. Provisional Application No. 63/511,438, filed Jun. 30, 2023, and entitled “FLUID DRIVEN DIAPHRAGM FOR PERSONAL DEVICES,” the entire contents of which is expressly incorporated by reference.

### STATEMENT RE: FEDERALLY SPONSORED RESEARCH/DEVELOPMENT

Not Applicable

### BACKGROUND

### Technical Field

The current disclosure is directed to fluid driven devices, and in particular to fluid driven personal devices that have a vibrating diaphragm.

### Background

Personal devices may be used for physical treatments including for example massages and/or sexual pleasure. These personal devices may have one or more actuators for providing a physical sensation to the user. The actuators may include for example asymmetrically weighted motors providing a vibrating action, motor driven pumps providing suction, as well as other types of mechanical actions.

Personal devices may also use actuators that are controlled by the flow of a fluid. Such devices may use a hydraulic pump connected to a fluidic circuit to pump a hydraulic fluid to one or more actuators connected to the circuit. The actuators may expand/contract and/or extend/retract under pressure of the hydraulic fluid.

While there are a wide range of existing personal devices that provide various types of massage and/or sexual stimulation, it is nonetheless desirable for alternative, additional and/or improved personal device.

### BRIEF DESCRIPTION OF THE DRAWINGS

Further features and advantages of the present disclosure will become apparent from the following detailed description taken in combination with the appended drawings, in which:

FIGS. 1A and 1B depict a personal device having a hydraulically driven diaphragm;

FIG. 2 depicts a further personal device having a hydraulically driven diaphragm;

FIGS. 3A and 3B depict a further personal device having a hydraulically driven diaphragm;

FIG. 4 depicts a further personal device having a hydraulically driven diaphragm;

FIG. 5A depicts a further personal device having a hydraulically driven diaphragm;

FIG. 5B depicts details of an output structure of the device of FIG. 5A;

FIG. 6 depicts a further personal device having a hydraulically driven diaphragm;

FIGS. 7A and 7B depict a further personal device having a hydraulically driven diaphragm;

FIGS. 8A and 8B depict a further personal device having a hydraulically driven diaphragm;

FIGS. 9A and 9B depict a further personal device having a hydraulically driven diaphragm;

FIGS. 10A and 10B depict a further personal device having a hydraulically driven diaphragm; and

FIGS. 11A, 11B and 11C depict a further personal device having a hydraulically driven diaphragm.

### DETAILED DESCRIPTION

In accordance with the present disclosure there is provided a device comprising: a reservoir for a hydraulic fluid; a diaphragm covering at least a portion of the reservoir; a dual sided reciprocating pump comprising a reciprocating piston within a chamber providing a pair of input/output (IO) ports for pumping the hydraulic fluid within the reservoir, each IO port arranged at respective ends of the pump; and an output structure arranged about at least one of the IO ports to direct an outflow of the hydraulic fluid from the at least one IO port to cause a vibration of the diaphragm.

In a further embodiment of the device, the output structure comprises an output jet having a reduced-size opening directed at the diaphragm.

In a further embodiment of the device, the output jet is adjustable to change a location on the diaphragm that the outflow is directed to.

In a further embodiment of the device, the output structure comprises a one-way valve to allow an inflow of the hydraulic fluid.

In a further embodiment of the device, the device further comprises a second output structure arranged at the other IO port.

In a further embodiment of the device, the output structure and the second output structure each comprise: an input one-way valve; an output one-way valve; and a directing structure for directing the outflow from the output one-way valve.

In a further embodiment of the device, each of the output structures comprise a tube connecting the respective input one-way valve to an opposite end of the pump.

In a further embodiment of the device, the reservoir is split into a plurality of sections. The device of claims 1 to 8, further comprising a secondary hydraulic actuator powered by the reciprocating pump.

In a further embodiment of the device, the device further comprising a pressure reservoir coupled to at least one output structure by a one-way valve to allow pressure to build within the fluid reservoir.

In a further embodiment of the device, the secondary actuator is coupled to the pressure reservoir through an electrically controllable valve.

In a further embodiment of the device, the device further comprising control electronics located in a sealed compartment separate from the reservoir.

In a further embodiment of the device, the sealed compartment further comprises a power circuit.

In a further embodiment of the device, the device is a personal massager.

In a further embodiment of the device, the device is a sexual stimulation device.

In a further embodiment of the device, the sexual stimulation device has is a phallic-style sexual stimulation device.

In a further embodiment of the device, the sexual stimulation device has is a wand-style sexual stimulation device.

Personal devices, which may be used for a variety of purposes including physical therapy, massage, sexual stimulation, etc., may use a reciprocating piston pump within a hydraulic fluid reservoir to pump the hydraulic fluid through an output structure that causes a diaphragm of the device to vibrate for example by wave motions or other patterns on. The diaphragm may be made from various materials that are clastic or resilient such as silicone, rubber, and/or latex based materials. As described in further detail below, the reciprocating pump may be dual sided so that each side of the device acts as both an input and output (IO) port for the hydraulic fluid depending upon the direction of the piston movement. The hydraulic fluid flowing from the reciprocating pump from one, or both IO ports, can be directed through the output structure to cause the diaphragm to vibrate in some manner by producing waves, resonating, or other movement patterns on the outer surface of the diaphragm. The output structure can be provided in various different physical embodiments, however, the output structure generally directs the force of the hydraulic fluid in order to generate a desired movement of the diaphragm. Placing the moving diaphragm, or at least a portion of the diaphragm, against an area of a user's body can provide a desired sensation, whether for physical therapy, massage, and/or sexual stimulation.

The personal device as described further herein allows the dual sided reciprocating pump along with the output structure to be placed within, or at least partially within, the reservoir for the hydraulic fluid. The diaphragm can cover a portion of the reservoir and as such the driving components, namely the pump, output structure and diaphragm, are all located within, or at least partially within the reservoir. Locating the driving components within the reservoir may eliminate or reduce the use of hydraulic circuits, valves, and actuators for providing the desired device operation.

The personal device provides a moving diaphragm that can produce vibrations from various movements resulting from the hydraulic fluid contacting the diaphragm. While other personal devices have made use of different hydraulic actuators for changing the dimensions and/or orientation of the device, the moving diaphragm of the current personal device may provide new modes of operations and types of devices not possible with previous hydraulic personal devices.

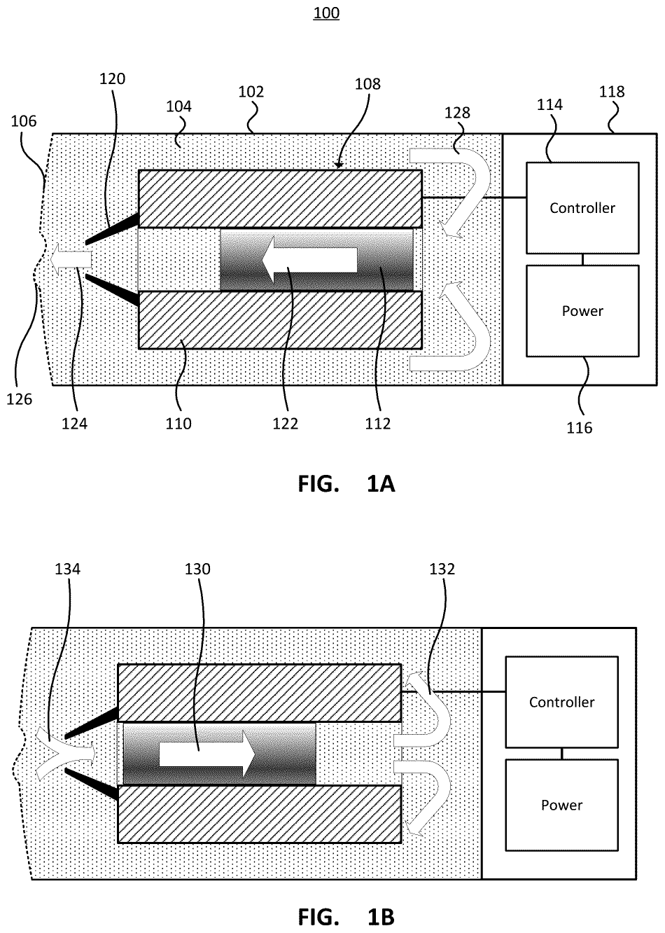

FIGS. 1A and 1B depict a personal device having a hydraulically driven diaphragm. The personal device 100 comprises a body 102 that at least partially encloses an internal reservoir 104. A diaphragm 106 encloses a portion of the reservoir 104. As depicted, the diaphragm 106 may seal an end or portion of the reservoir. Alternatively, the reservoir may be fully sealed by a membrane (not shown) and the diaphragm can be secured over a portion of the reservoir membrane.

The reservoir 104 can be filled with a hydraulic fluid such as water, although other hydraulic fluids may be used that provide desirable characteristics such as evaporation rates, chemical reactions with materials of the personal device 100, and safety for personal use. A reciprocating pump 108 is located within, or at least partially within, the reservoir 104. The pump 108 may be situated within the reservoir by one or more support structures, which are not depicted in FIGS. 1A and 1B for simplicity.

The reciprocating pump 108 comprises a housing 110 within which a piston 112 moves back and forth under electromagnetic action. The reciprocating pump 108 is coupled to a controller 114 and power supply 116 in order to control the operation of the pump 108. The controller 114 and power supply 116 may be located in a compartment 118 sealed off from the hydraulic fluid of the reservoir 104. It is possible that the controller 114 and/or power supply 116 could be located within the reservoir if the controller or power supply are appropriately sealed, or if the hydraulic fluid is non-conductive.

An output structure 120 is arranged within the reservoir 104 in order to direct an output flow from one side of the pump 108 to the diaphragm 106. As depicted, the output structure 120 may be connected to one end of the pump and may be formed to act as a jet that increases the velocity of the hydraulic fluid exiting the pump and directing the flow to the diaphragm. As the piston 112 moves in a stroke from one side to the other as depicted by arrow 122, hydraulic fluid that has entered the piston chamber is forced out by the piston stroke and directed onto the diaphragm by the output structure 120 as depicted by arrow 124. The impact of the hydraulic fluid on the diaphragm causes the diaphragm to move as depicted by wave 126. At the opposite end of the piston 112, as it moves as depicted by arrow 122, hydraulic fluid enters the chamber the piston moves within from the reservoir.

FIG. 1B depicts the device 100 with the piston 112 returning back to the position depicted in FIG. 1A. As depicted, when the piston moves back in a return stroke depicted by arrow 130, the hydraulic fluid that was drawn into the piston chamber on the previous stroke depicted in FIG. 1A, is forced out the end of the pump depicted by arrows 132. As the piston moves on the return stroke, hydraulic fluid may be drawn in to the piston chamber again through the output structure 120. Although the hydraulic fluid is depicted in FIGS. 1A and 1B as flowing into and out of the same portion of the output structure, it is possible for the output structure to comprise different flow paths for the output and input fluid flows.

As described above, the reciprocating pump may force hydraulic fluid out of an output structure to impact a diaphragm and cause movement of the diaphragm during a first piston stroke. The return stroke may draw the hydraulic fluid back into the pump, possibly through the output structure. As such the reciprocating pump alternates between pumping the hydraulic fluid through the output structure and onto the diaphragm and drawing hydraulic fluid back into the pump. The various parameters of the personal device may be adjusted in order to provide desired movement patterns of the diaphragm. The parameters may include for example the pump characteristics such as stroke length, piston diameter, stroke frequency, as well as other characteristics of the device such as reservoir size and shape, hydraulic fluid properties such as viscosity, characteristics of the diaphragm such as material elasticity, thickness, tension, as well characteristics of the output structure such as the shape and orientation of the structure and the proximity to the diaphragm. Various different examples of devices with fluid driven diaphragms are described in further detail below.

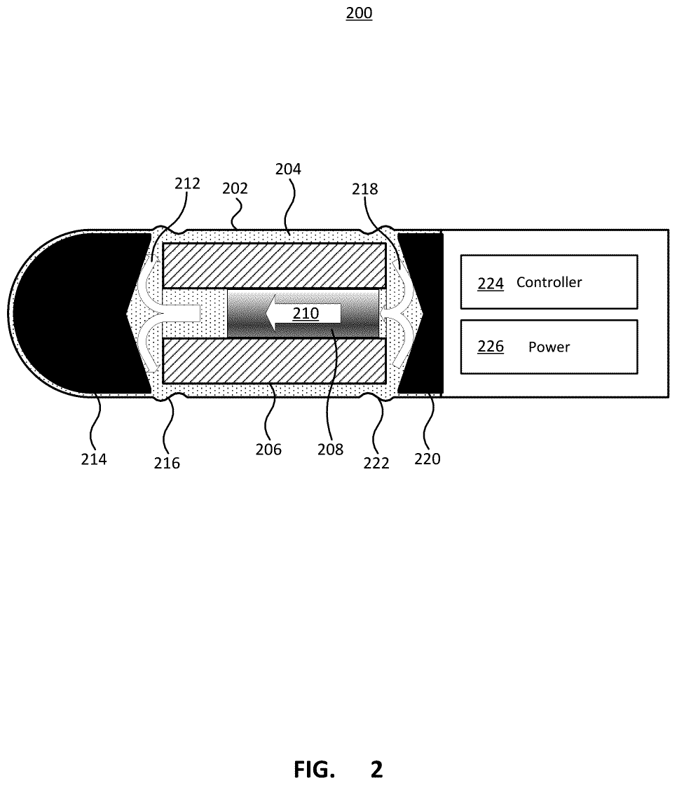

FIG. 2 depicts a further personal device having a hydraulically driven diaphragm. In contrast to the device depicted in FIGS. 1A and 1B which had a single sided output structure at one IO port of the pump, the device 200 comprises output structures at each respective IO port of the pump. As depicted in FIG. 2, the device 200 is depicted as having a phallic shape body with at least a portion covered by a diaphragm 202. The diaphragm 202 is formed of a resilient material and at least partially covers an internal reservoir 204 filled with a hydraulic fluid. A dual sided reciprocating pump 206 is located within the reservoir 204. The pump 206 has a piston 208 that moves back and forth within a bore of the pump. As depicted in FIG. 2, when the piston moves from the right to left as depicted by arrow 210, the hydraulic fluid is forced out of an input/output (IO) port of the pump. The fluid forced out of the IO port of the pump, depicted by arrow 212, impacts an output structure 214 that redirects the fluid output from the pump onto a portion of the diaphragm. As depicted, the redirection of the fluid can cause the diaphragm to vibrate from waves, ripples, or other patterns 216 formed on the diaphragm. Similarly, at a second IO port of the pump, as the piston 208 moves from the right to left forcing fluid out of a first IO port, the piston also sucks the fluid into the piston bore as depicted by arrow 218. A second output structure 220 can be located at the second IO port. The second output structure 220 in addition to redirecting the fluid to cause the diaphragm 222 to vibrate can also restrict the fluid flowing into IO port which may help in establishing the waves, ripples, or other patterns 222 on the diaphragm providing the vibration. The reciprocating nature of the pump can cause a repeating expulsion and in-take of the fluid redirected by the output structure that can for example cause a standing resonant wave, or other type of pattern, to form on the diaphragm. The reciprocating motion of the piston within the pump bore may be driven by electromagnetics controlled by a controller 224 which may be located in a compartment that may also house the power source 226. The compartment may be sealed from the reservoir 204.

The device 200 depicted in FIG. 2 may have a generally cylindrical body. The output structures 214, 220 located at respective ends of the reciprocating pump may be symmetric about a longitudinal axis of the cylindrical body of the device. A gap between the pump and perimeter of the output structures may be continuous or may be segmented. Additionally, the size of the gap, including possible overhangs of the pump, may be varied to suit the particular application.

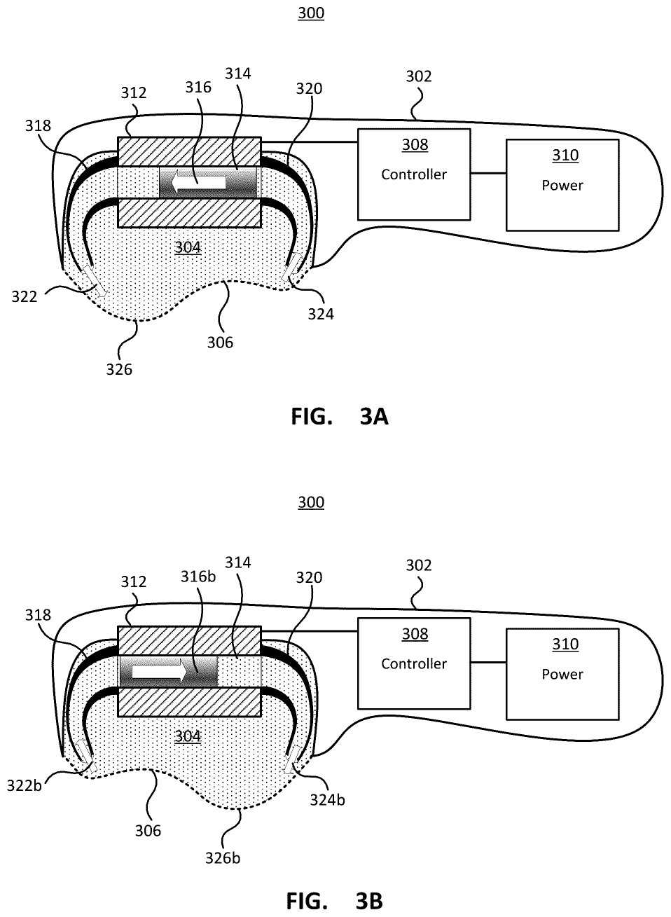

FIGS. 3A and 3B depict a further personal device having a hydraulically driven diaphragm. Similar to the device 200 described above with reference to FIG. 2, the device 300 comprises output structures at each end of the dual side reciprocating pump. However, in contrast to the generally phallic body of the device 200, the device 300 may be shaped as a handheld massager or wand. The device 300 comprises a body 302 with an internal reservoir 304 holding a hydraulic fluid. A portion of the reservoir may be covered by, or formed by, a diaphragm 306 made of a resilient material. The body may include a compartment sealed off from the reservoir that houses controller 308 and power 310 components. The power 310 and controller 308 components may control operation of a reciprocating pump 312 that is at least partially within the reservoir 304. The pump comprises a piston 314 that can move back and forth within a bore of a pump housing. Coupled to the pump 312 at a respective IO port at each end of the pump are respective output structures 318, 320 that direct on outflow of hydraulic fluid in a manner that causes the diaphragm 306 to vibrate, for example by waves or other patterns formed on the diaphragm. The output structures 318, 320 direct the hydraulic fluid at the diaphragm. For example, as the piston 314 moves from the right to the as depicted by arrow 316 the hydraulic fluid within the bore of the pump is forced out through the IO port and the output structure 318, which acts as a jet for redirecting the hydraulic fluid onto the diaphragm to drive it in a manner that can provide a physical vibration sensation to a user when the diaphragm is placed against the user's body. As the fluid is driven out of the pump, it is simultaneously drawn into the bore at the opposite end of the pump through the other output structure 320. The output of the fluid depicted by arrow 322 and the intake of the fluid, depicted by arrow 324 may cause a wave 326 to form on the diaphragm 306. As the piston moves in the opposite direction, depicted by arrow 316b in FIG. 3B, the fluid flow reverses and so the fluid is drawn into the cylinder bore through output structure 318 as depicted by arrow 322b and forced out of the opposite end of cylinder bore through the output structure 320 and directed onto the diaphragm as depicted by arrow 324b. The reciprocating motion of the pump, and so the cyclic intake/output of the pump directed to the diaphragm by the output structures can cause a ripple or wave 326b to move across the diaphragm, which may be used to provide a physical sensation to a user as the device is placed in contact with the user's body.

While the above has described, with particular reference to FIGS. 1A, 1B, 3A, 3B and 4, output structures that direct to the output flow of the hydraulic fluid from the pump towards the diaphragm to generate ripples, waves or other patterns that cause the diaphragm to vibrate, the output structures do not need to direct jets of fluid toward the diaphragm. Various output structures are possible that guide or direct the fluid out of, and possibly into, the reciprocating pump in a manner that causes vibrations on the diaphragm.

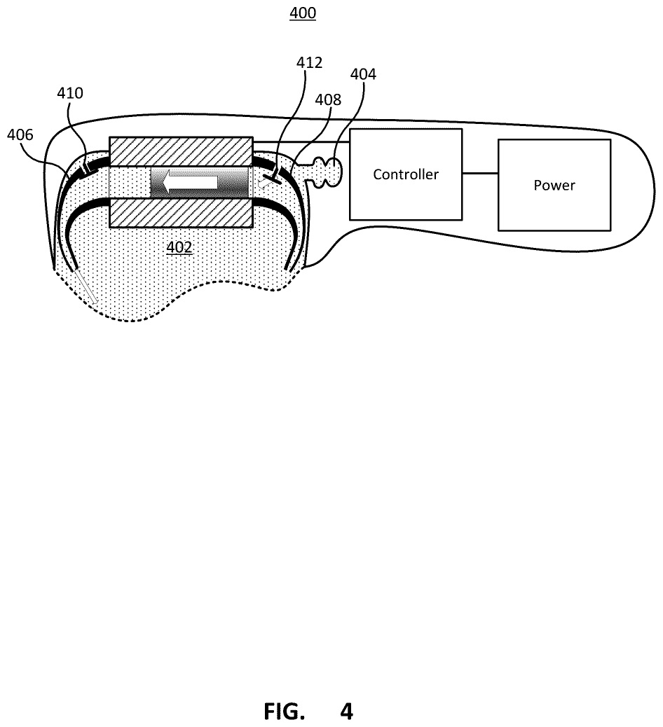

FIG. 4 depicts a further personal device having a hydraulically driven diaphragm. The device 400 is similar to the device 300 described above and as such only those differences will be described in further detail. The device 400 comprise a reservoir 402 that includes an expansion/contraction bellows 404 that can provide a space for additional fluid either to replace fluid into the main reservoir as it is lost, or the volume decreased for example do to being at different temperatures or altitudes. Similarly, the bellows may provide an additional volume for hydraulic fluid if the volume of the fluid in the main reservoir increases, possibly because of temperature or elevation/pressure changes.

In addition to the expansion/contraction bellows 404, the device 400 may also comprise modified output structures 406, 408 that each include one-way valves 410, 412 that provide an increased area for fluid to flow through during an intake cycle. As the fluid is being drawn into the pump through output structure 408, the one-way valve 412 opens allowing fluid to not only be drawn in through the jet opening but also through the valve 412. As the fluid is forced out through the output structure, for example output structure 406 in FIG. 4, the one-way valve 410 is closed and so all of the hydraulic fluid is forced out through the single jet-like opening of the output structure 406.

Although not depicted in FIG. 4, the output structures may be adapted in other ways as well. For example, the output structures may be formed of a deformable material that causes the end of the output structure to move as the fluid flows out. Additionally, or alternatively, the output structure may be mechanically linked to one or more actuators in order to controllably move the position of the output structure.

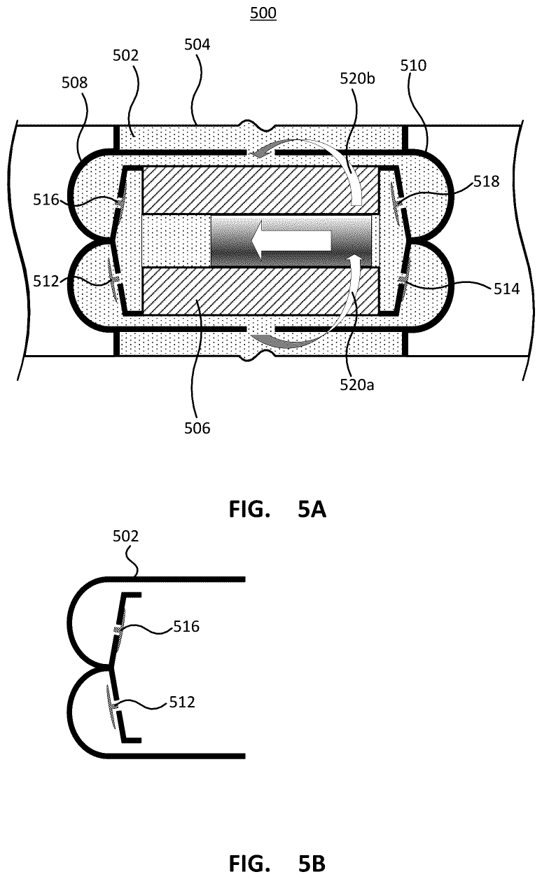

FIG. 5A depicts a portion of a further personal device having a hydraulically driven diaphragm. The hydraulically driven diaphragm portion 500 may be incorporated into various different device form factors. The hydraulically driven diaphragm portion 500 comprises a reservoir 502 that is at least partially covered by a diaphragm 504. A dual sided reciprocating pump 506 is located within the reservoir. Output structures 508, 510 may be coupled to IO ports at respective ends of the pump. The output structure 508 is depicted in isolation in FIG. 5B. The output structures 508, 510 may be formed as separate components or as unitary component, and may be secured to the pump or formed integrally with the pump, or possibly the body of the device. Regardless of how the output structures are manufactured, they may each comprise one-way output 512, 514 and one-way input 516, 518 valves as well as a directing structure 520 that directs the outflow of the hydraulic fluid to a desired location in order to generate the desired vibrations on the diaphragm, possibly in conjunction with other structures of the device, such as a housing of the pump in FIGS. 5A and 5B. As depicted each output structure may comprise a single output valve and a single input valve, although additional input and/or output valves may be provided. The output structure may have one or more channels, or similar structures that can fluidically connect the IO ports to reservoir and direct the fluid flow onto the diaphragm 504. The arrangement of the input and output valves and the output structures directing the fluid flow can change the waves, ripples or other patterns produced on the diaphragm by the pump and output structures. For example, as depicted in FIG. 5A, The output valve at one end and the input valve at the outer end of the pump may be opened to the reservoir such that the fluid flow exits the output valve and is directed through the output structure around the device, depicted by arrows 522a 522b, through the output structure at the other end of the pump and into the pump through the input valve. The particular arrangement may cause a ripple or wave to rotate about the device from one end of the pump to the other providing a vibration on the surface of the diaphragm. Further, it is possible to section off portions of the reservoir in order to further control or direct the fluid flow.

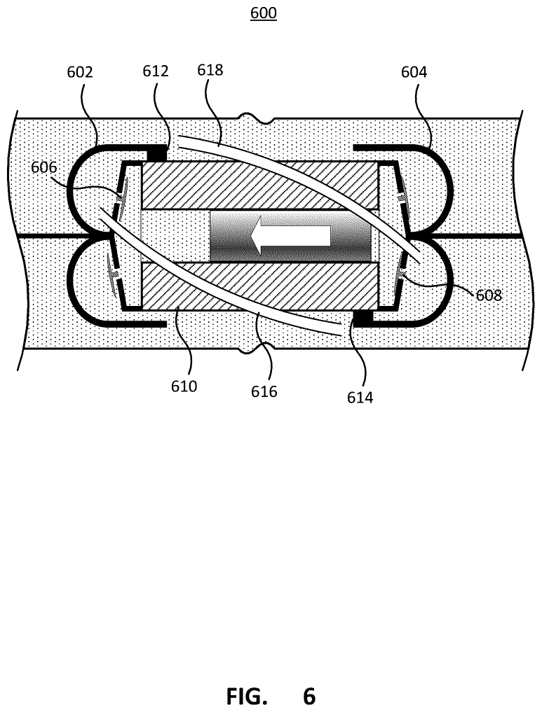

FIG. 6 depicts a further portion of personal device having a hydraulically driven diaphragm. The hydraulically driven diaphragm portion 600 is similar to that of FIGS. 5A and 5B; however, the output structures 602, 604 are adapted to change the wave pattern. The intake valves 606, 608 of each output structure at respective ends of the pump 610 are sealed 612, 614 from the reservoir at the respective end of the pump. The intake valves 606, 608 are coupled to the reservoir at the opposite end of the pump by, for example, tubing 616, 618 and as such the fluid intake for similar strokes compared to FIG. 5A will be from the reservoir at opposite sides of the pump, which can change the ripple or wave pattern on the diaphragm providing vibrations.

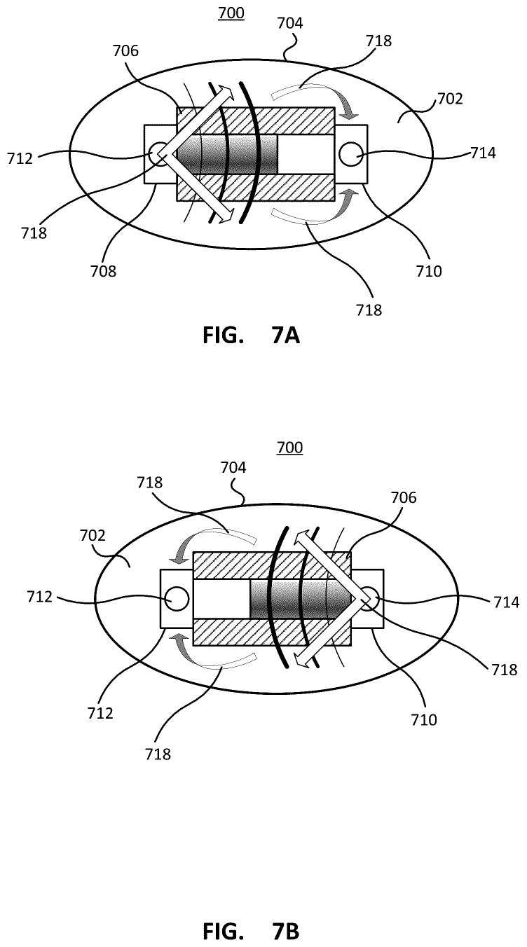

The above has described devices that may incorporate a hydraulically driven diaphragm into a portion of the device. It is possible for the device to comprise substantially only the diaphragm, or diaphragms. The arrangement of the reservoirs, inputs and outputs of the pumps may be varied to provide different waves, ripples, or other patterns on the diaphragm. Devices that are substantially only diaphragms are depicted in FIGS. 7A through 10B.

FIGS. 7A and 7B depict a further personal device having a hydraulically driven diaphragm. The device may be provided as a clamshell like device with a single diaphragm or a pair of diaphragms. As depicted, the device 700 comprises a reservoir 702, which may be substantially all of an interior volume of the device. The reservoir 702 may be covered by a diaphragm. A dual sided reciprocating pump 706 may be located within the reservoir with output structures 708, 710 arranged at respective ends of the pump. The output structures 708, 710 comprise output valves 712, 714 and intake valves, which in FIG. 7A, 7B are located on the underside of the output structures.

As depicted in FIGS. 7A and 7B as the piston moves back and forth within the bore of the pump, the fluid is expelled out of one of the outputs and drawn into the intake at the opposite end of the pump, and on the underside of the intake. As such the fluid flows out and around the device as depicted by arrows 716, 718 creating vibrations on the diaphragm as a wave pattern, depicted schematically by wave front 720, that can run back and forth over the surface of the diaphragm.

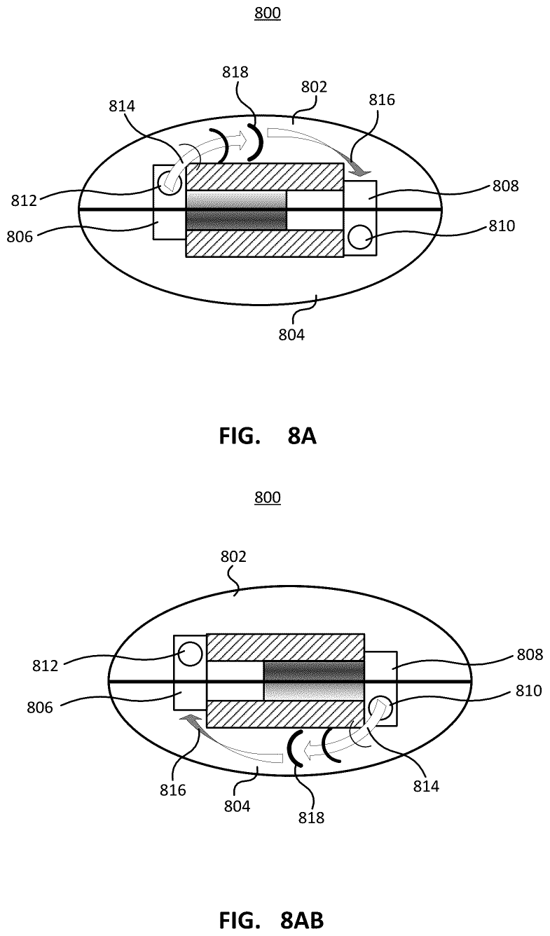

FIGS. 8A and 8B depict a further personal device having a hydraulically driven diaphragm. The device 800 is similar to that of 700, however the reservoir may be split into two separate sections 802, 804. The output structures 806, 808 may be partially located in each of the reservoir sections. Each output structure may have an output valve 810, 812 and input valve, which is not visible in the figures. The output valve and input valve of the same output structure are located in different reservoir sections so that fluid output from an output valve of one of the output structures flows to the input valve of the other output structure as depicted by arrows 814, 816. The arrangement of the input and output valves and the separation of the reservoir sections causes vibrations on the diaphragm as waves or ripples 818 that run down the respective sides of the device 800.

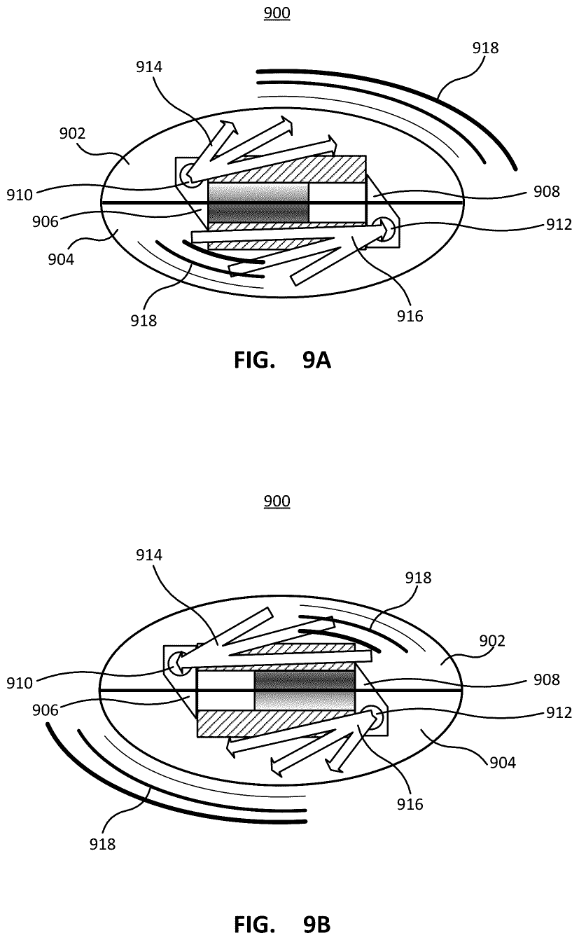

FIGS. 9A and 9B depict a further personal device having a hydraulically driven diaphragm. The device 900 is similar to the device 800 with two separate reservoirs 902, 904. However, rather than each output structure having separate input and output valves, the output structures 906, 908 have a single port 910, 912 that is used as both the output and intake. As depicted the water flows out from and into the output structures from the same ports as depicted by arrows 914, 916 which can create a vibration on the diaphragm as a back and forth sloshing motion 918 across the diaphragm.

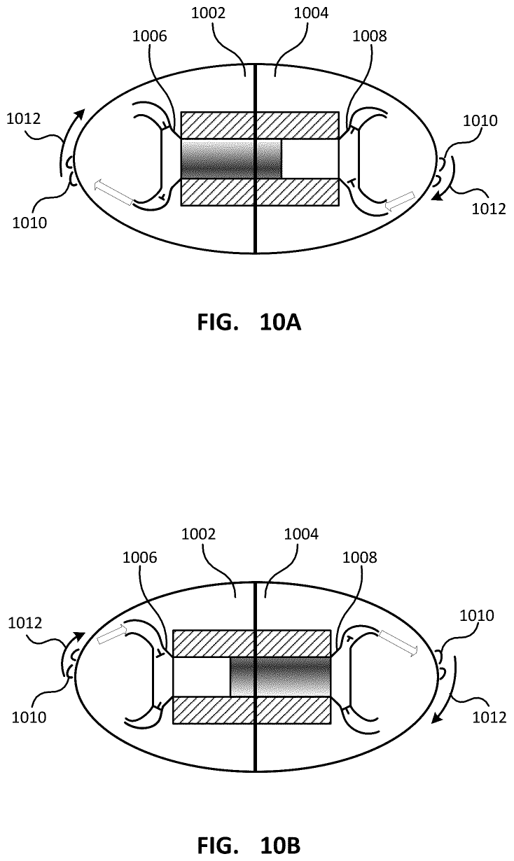

FIGS. 10A and 10B depict a further personal device having a hydraulically driven diaphragm. The device 1000 is similar to the device 900 and has two separate reservoirs 1002, 1004. However rather than having the reservoirs split along a longitudinal axis of the pump, the reservoirs 1002, 1004 are split along an axis perpendicular to the longitudinal axis of the pump. As depicted in FIGS. 10A and 10B, the output structures 1006, 1008 may be similar to the output structures described above with reference to FIG. 4 however rather than having a single jet structure, each of the output structures 1006, 1008 comprise a jet like extension for each of the output and input. It is noted that the size of the output and input jets may differ so that the input has a larger opening to provide less flow restriction to the input flow. The input and output jets of the output structures can cause a vibration on the diaphragm as a wave or ripple 1010 that moves or walks along the surface of the diaphragm as depicted by arrows 1012.

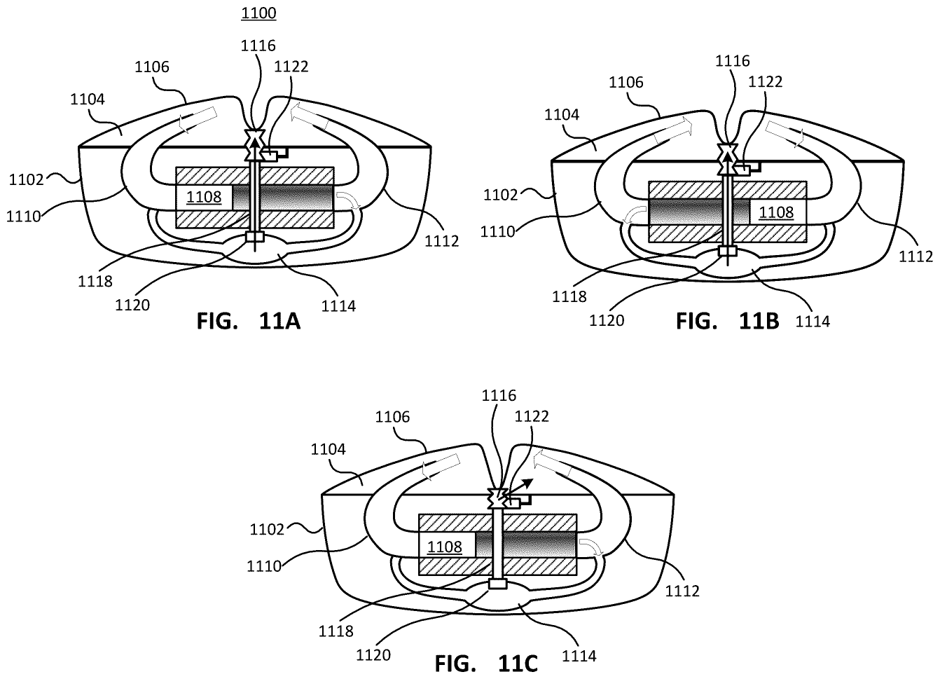

FIGS. 11A, 11B and 11C depict a further personal device having a hydraulically driven diaphragm. The device 1100 incorporates a hydraulically driven diaphragm as well as other hydraulic actuators. The device 1100 comprises a body 1102 and reservoir 1104 that is at least partially covered by a diaphragm 1106. In contrast to the devices described above, the device 1100 has a dual sided reciprocating pump 1108 that is located out of the reservoir 1104, although it could also be located within the reservoir. The reciprocating pump has IO ports at each end which are coupled to respective output structures 1110, 1112 that direct the output flow onto the diaphragm 1106. Although not depicted in FIGS. 11A-11C, the output structures 1110, 1112 may incorporate one way valves in order to provide less restricted fluid flow on the input side.

In addition to providing output structures that cause vibrations as waves, ripples or other patterns on the diaphragm surface, the device may further comprise a secondary hydraulic actuation component that utilizes pressure from the pumped fluid. As depicted in FIGS. 11A and 11B a portion of the outflow of the fluid from the pump may be diverted through one way valves (not depicted) to a secondary pressure reservoir 1114. The one way valves ensure that the fluid builds pressure in the pressure reservoir 1114. The pressure reservoir 1114 may be connected to the secondary actuator 1116 through one or more pipes or tubes 1118 with the fluid flow controlled by one or more electrically controllable valves 1120. When the valve(s) 1120 are open, the fluid pressure causes the actuator 1116 to extend as depicted in FIGS. 11A and 11B. The valve(s) 1120 may be closed and the fluid pressure released into the reservoir through one or more controllable valves 1122 as depicted in FIG. 11C. With the pressure released, the actuator 1116 may retract. As depicted, the actuator that can controllably extend and retract may be attached to a portion of the diaphragm so that a pocket can expand and contract, which may provide a vacuum or sucking sensation when placed against a user's body. As will be appreciated, although the hydraulically driven diaphragm and the secondary actuator are driven by the same pump, they may be controlled independently such that the driving of the diaphragm may occur with or without the secondary actuator operating.

It will be appreciated that although not described in the above examples, the devices described may include various interface components for providing a control interface to the user. The control interface could be a simple on/off button or more complex such as a vocal interface, touch interface, or multiple buttons or switches. Additionally, the control interface may be provided wirelessly such that control interface of the device may be provide on one or more external devices such as a remote control, or a user's mobile device.

A hydraulically driven diaphragm system was described above by way of various illustrative embodiments. It will be appreciated that features described with respect to one embodiment may be incorporated into other embodiments. Additionally, components of the different embodiments may be changed, modified, or replaced with other components that perform the same functionality. For example, the one way valves have been depicted as a one-way mushroom style valve that due to the physical design of the valve only allow fluid to flow in one direction could be replaced with electrically controllable valves that when open may allow fluid flow in both directions, but that are electronically controlled to only be open during a portion of the reciprocating pump's cycle.

What is claimed is:

1. A device comprising:
a reservoir for a hydraulic fluid;
a diaphragm covering at least a portion of the reservoir;
a dual sided reciprocating pump comprising a reciprocating piston within a chamber providing a pair of input/output (IO) ports for pumping the hydraulic fluid within the reservoir, each IO port arranged at respective ends of the pump; and
an output structure arranged about at least one of the IO ports to direct an outflow of the hydraulic fluid from the at least one IO port to cause a vibration of the diaphragm.

2. The device of claim 1, wherein the output structure comprises an output jet having a reduced-size opening directed at the diaphragm.

3. The device of claim 2, wherein the output jet is adjustable to change a location on the diaphragm that the outflow is directed to.

4. The device of claim 2, wherein the output structure comprises a one-way valve to allow an inflow of the hydraulic fluid.

5. The device of claim 1, further comprising a second output structure arranged at the other IO port.

6. The device of claim 5, wherein the output structure and the second output structure each comprise:
an input one-way valve;
an output one-way valve; and
a directing structure for directing the outflow from the output one-way valve.

7. The device of claim 6, wherein each of the output structures comprise a tube connecting the respective input one-way valve to an opposite end of the pump.

8. The device of claim 1, wherein the reservoir is split into a plurality of sections.

9. The device of claim 1, further comprising a secondary hydraulic actuator powered by the reciprocating pump.

10. The device of claim 9, further comprising a pressure reservoir coupled to at least one output structure by a one-way valve to allow pressure to build within the fluid reservoir.

11. The device of claim 10, wherein the secondary actuator is coupled to the pressure reservoir through an electrically controllable valve.

12. The device of claim 1, further comprising control electronics located in a sealed compartment separate from the reservoir.

13. The device of claim 1, wherein the sealed compartment further comprises a power circuit.

14. The device of claim 1, wherein the device is a personal massager.

15. The device of claim 1, wherein the device is a sexual stimulation device.

16. The device of claim 15, wherein the sexual stimulation device has is a phallic-style sexual stimulation device.

17. The device of claim 15, wherein the sexual stimulation device has is a wand-style sexual stimulation device.
